(19) United States
(12) Patent Application Publication
(10) Pub. No.: US 2024/0403042 A1
(43) Pub. Date: Dec. 5, 2024

(54) CLOUD RESOURCE PROJECT MANAGEMENT

(71) Applicant: VMware LLC, Palo Alto, CA (US)

(72) Inventors: Ventsyslav Raikov, Sofia (BG); George P. Dimitrov, Sofia (BG); Alexander Dimitrov, Sofia (BG); Ivan Slavov, Sofia (BG); Atanas Todorov, Sofia (BG)

(21) Appl. No.: 18/327,641

(22) Filed: Jun. 1, 2023

(51) Int. Cl. G06F 8/77

(52) U.S. Cl. CPC G06F 8/77

(57) ABSTRACT

Methods, apparatus, systems, and articles of manufacture are disclosed to manage cloud project resources. An example apparatus includes instructions to program programmable circuitry to: monitor first events for a first reference to a project, the project to coordinate access to computing resources in a cloud or hybrid cloud computing environment; manage a record stored for the project, the record including a status of the project, the status updated in response to the first reference; delete the project in response to a delete instruction in the first events when the status of the project indicates that the project is not in use; monitor second events for a second reference to the project; and restore the project when the second events include the second reference.

### FIELD OF THE DISCLOSURE

This disclosure relates generally to management of cloud resources and, more particularly, to apparatus and methods for management of cloud project resources.

### BACKGROUND

Cloud servers include compute, memory, and storage resources to remotely perform services and functions. In recent years, increasingly large and complex computational workloads have been deployed to cloud servers. Previously, such workloads would be executed on-premises, simplifying monitoring and management. Further, virtualizing computer systems, on the cloud or otherwise, can enable execution of multiple computer systems on a single hardware computer, replicating computer systems, moving computer systems among multiple hardware computers, and so forth.

### BRIEF DESCRIPTION OF THE DRAWINGS

FIG. 1 depicts an example system constructed in accordance with the teachings of this disclosure to manage a cloud computing platform.

FIG. 2 is a block diagram of an implementation of the example infrastructure automation manager and the example cloud services manager of FIG. 1.

FIG. 3 shows an example configuration and message exchange of the infrastructure automation manager and the cloud services manager for project management.

FIG. 4 is an illustration of a control flow including an example exchange of instructions and data between the example project migration circuitry, the example memory circuitry, and the example cloud services manager.

FIG. 5 is an illustration of a control flow including an example exchange of instructions and data between the example synchronization circuitry, the example resource management circuitry, and a services layer of the event handler circuitry.

FIG. 6 is an illustration of a control flow including an example exchange of instructions and data between the example cloud services manager, the example infrastructure automation manager, and the example deployment environment.

FIG. 7 is a flowchart representative of example machine readable instructions and/or example operations that may be executed by example processor circuitry to implement the example infrastructure automation manager and/or the example cloud services manager of FIG. 2.

FIG. 8 is a block diagram of an example processing platform including programmable circuitry structured to execute, instantiate, and/or perform the example machine readable instructions and/or perform the example operations of FIG. 7 to implement the example infrastructure automation manager and the example cloud services manager of FIGS. 1-3.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s). Programmable circuitry may also be referred to in certain examples as “processor circuitry.”

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Virtual computing services enable one or more assets to be hosted within a computing environment. As disclosed herein, an asset is a computing resource (physical or virtual) that may host a wide variety of different applications such as, for example, an email server, a database server, a file server, a web server, etc. Example assets include physical hosts (e.g., non-virtual computing resources such as servers, processors, computers, etc.), virtual machines, containers that run on top of a host operating system without the need for a hypervisor or separate operating system, hypervisor kernel network interface modules, etc. In some examples, an asset may be referred to as a compute node, an endpoint, a data computer end-node or as an addressable node.

Virtualization technologies can be used for computing, storage, and/or networking, for example. Using virtualization, hardware computing resources and/or other physical resources can be replicated in software. One or more application programming interfaces (APIs) can be implemented to provide access to virtualized resources for users, applications, and/or systems while limiting or masking underlying software and/or hardware structure.

Cloud computing is based on the deployment of many physical resources across a network, virtualizing the physical resources into virtual resources, and provisioning the virtual resources to perform cloud computing services and applications.

A virtual machine is a software computer that, like a physical computer, runs an operating system and applications. An operating system installed on a virtual machine is referred to as a guest operating system. Because each virtual machine is an isolated computing environment, virtual machines (VMs) can be used as desktop or workstation environments, as testing environments, to consolidate server applications, etc. Virtual machines can run on hosts or clusters. The same host can run a plurality of VMs, for example.

Virtual machines operate with their own guest operating system on a host (e.g., a host server) using resources of the host virtualized by virtualization software (e.g., a hypervisor, virtual machine monitor, etc.). Numerous virtual machines can run on a single computer or processor system in a logically separated environment (e.g., separated from one another). A virtual machine can execute instances of applications and/or programs separate from application and/or program instances executed by other virtual machines on the same computer.

In certain examples, a VM can host a container and/or a container can be implemented for virtualization in place of the VM. Containers (e.g., Docker®, Rocket™, Linux® containers (LXC), etc.) can be used in computing environments to run applications, programs, utilities, and/or any other software in isolation. Containers can be used to achieve improved resource management (e.g., resources used by containerized components are isolated for use only by those components that are part of the same container) and/or for security purposes (e.g., restricting access to containerized files or components). In addition, containers can also be used to achieve lightweight, reproducible application deployment. While a container is intended to run as a well-isolated instance of software in a host environment, the security properties of a container image and/or a container can impact operations of other resources and/or processes in a host computer environment in which the container executes.

In certain examples, a hybrid cloud infrastructure can be provided. In a hybrid cloud infrastructure, cloud-based resources are combined with on-premises infrastructure (also referred to as a private cloud). The hybrid cloud infrastructure provides a common orchestration of both cloud-based and on-premises elements to enable all the elements to work together, such as in an infrastructure-as-a-service (IaaS) platform. Software and other process automation can be driven by the IaaS platform of the hybrid infrastructure, for example.

Management applications (e.g., cloud management such as vSphere® Automation Cloud Assembly) provide administrators the ability to manage and/or adjust of assets and/or entities (e.g., virtualized resources, virtual machines, etc.) in a computing environment. Administrators can inspect the assets, see the organizational relationships of a virtual application, filter log files, overlay events versus time, etc. In some examples, an application may install one or more plugins (sometimes referred to herein as “agents”) at the asset to perform monitoring operations. For example, a first management application may install a first monitoring agent at an asset to track an inventory of physical resources and logical resources in a computing environment, a second management application may install a second monitoring agent at the asset to provide real-time log management of events, analytics, etc., and a third management application may install a third monitoring agent to provide operational views of trends, thresholds and/or analytics of the asset, etc. However, executing the different monitoring agents at the asset consumes resources (e.g., physical resources) allocated to the asset. In addition, some monitoring agents may perform one or more similar task(s).

In some systems (e.g., infrastructure management platforms such as vRealize® Automation, etc.), a user and/or administrator may set up and/or create a cloud account (e.g., a Google® cloud platform (GCP) account, a network security virtualization platform (NSX) account, a VMware® cloud foundation (VCF) account, a vSphere® account, etc.) to connect a cloud provider and/or a private cloud so that the management applications can collect data from regions of datacenters. Additionally, cloud accounts allow a user and/or administrator to deploy and/or provision cloud templates to the regions. A cloud template is a file that defines a set of resources. The cloud template may utilize tools to create server builds that can become standards for cloud applications.

Certain examples provide an infrastructure management platform (e.g., vRealize® Automation, etc.) to provision and configure computing resources. The infrastructure management platform can also automate delivery of container-based applications, for example. The infrastructure management platform provides tools and associated APIs to facilitate interaction, deployment, and management of computing resources in the cloud and/or hybrid cloud infrastructure or environment.

Certain examples provide a management platform, such as a cloud services platform (e.g., VMware® Cloud Services Platform (CSP), Google® Cloud Services Platform, etc.). The cloud services platform provides APIs for identity and access management in the cloud and/or hybrid cloud environment. VMs can also be deployed via the API of the cloud services platform, for example.

### Example Virtualization Environments

Many different types of virtualization environments exist. Three example types of virtualization environment are: full virtualization, paravirtualization, and operating system virtualization.

Full virtualization, as used herein, is a virtualization environment in which hardware resources are managed by a hypervisor (e.g., a virtual machine monitor or computer software, hardware and/or firmware that creates and runs virtual machines) to provide virtual hardware resources to a virtual machine. In a full virtualization environment, the virtual machines do not have direct access to the underlying hardware resources. In a typical full virtualization environment, a host operating system with embedded hypervisor (e.g., VMware ESXi®) is installed on the server hardware. Virtual machines including virtual hardware resources are then deployed on the hypervisor. A guest operating system is installed in the virtual machine. The hypervisor manages the association between the hardware resources of the server hardware and the virtual resources allocated to the virtual machines (e.g., associating physical random access memory (RAM) with virtual RAM). Typically, in full virtualization, the virtual machine and the guest operating system have no visibility and/or direct access to the hardware resources of the underlying server. Additionally, in full virtualization, a full guest operating system is typically installed in the virtual machine while a host operating system is installed on the server hardware. Example full virtualization environments include VMware ESX®, Microsoft Hyper-V®, and Kernel Based Virtual Machine (KVM).

Paravirtualization, as used herein, is a virtualization environment in which hardware resources are managed by a hypervisor to provide virtual hardware resources to a virtual machine and guest operating systems are also allowed direct access to some or all of the underlying hardware resources of the server (e.g., without accessing an intermediate virtual hardware resource). In a typical paravirtualization system, a host operating system (e.g., a Linux-based operating system) is installed on the server hardware. A hypervisor (e.g., the Xen® hypervisor) executes on the host operating system. Virtual machines including virtual hardware resources are then deployed on the hypervisor. The hypervisor manages the association between the hardware resources of the server hardware and the virtual resources allocated to the virtual machines (e.g., associating physical random access memory (RAM) with virtual RAM). In paravirtualization, the guest operating system installed in the virtual machine is configured also to have direct access to some or all of the hardware resources of the server. For example, the guest operating system may be precompiled with special drivers that allow the guest operating system to access the hardware resources without passing through a virtual hardware layer. For example, a guest operating system may be precompiled with drivers that allow the guest operating system to access a sound card installed in the server hardware. Directly accessing the hardware (e.g., without accessing the virtual hardware resources of the virtual machine) may be more efficient, may allow for performance of operations that are not supported by the virtual machine and/or the hypervisor, etc.

Operating system virtualization is also referred to herein as container virtualization. As used herein, operating system virtualization refers to a system in which processes are isolated in an operating system. In a typical operating system virtualization system, a host operating system is installed on the server hardware. Alternatively, the host operating system may be installed in a virtual machine of a full virtualization environment or a paravirtualization environment. The host operating system of an operating system virtualization system is configured (e.g., utilizing a customized kernel) to provide isolation and resource management for processes that execute within the host operating system (e.g., applications that execute on the host operating system). The isolation of the processes is known as a container. Several containers may share a host operating system. Thus, a process executing within a container is isolated the process from other processes executing on the host operating system. Thus, operating system virtualization provides isolation and resource management capabilities without the resource overhead utilized by a full virtualization environment or a paravirtualization environment. Alternatively, the host operating system may be installed in a virtual machine of a full virtualization environment or a paravirtualization environment. Example operating system virtualization environments include Linux Containers LXC and LXD, Docker™, OpenVZ™, etc.

In some instances, a data center (or pool of linked data centers) may include multiple different virtualization environments. For example, a data center may include hardware resources that are managed by a full virtualization environment, a paravirtualization environment, and an operating system virtualization environment. In such a data center, a workload may be deployed to any of the virtualization environments.

### Example Project Management Systems and Methods

Certain examples enable client definition and deployment of architecturally complex virtual computing environments. Such virtual computing environments can include multiple machines, software, etc. While some systems (e.g., vRealize Automation®, etc.) provide functionality to enable common scenarios “out of the box,” certain examples enable customization for specific functionality. Certain examples provide a flexible and powerful extensibility mechanism that enables cloud administrators and/or other users, for example, to fine tune a resource provisioning process.

In certain examples, a project is created to identify users that can provision workloads, define resource deployment priority, define resource deployment cloud zone, set a maximum number of allowed deployment instances, etc. A project defines a set of users and associated level of access to underlying services and resources accessible to the set or group of users via the project. Using a project, access to resources such as blueprints, infrastructure objects, etc., can be shared between identified users. In certain examples, projects can be created and/or used by both the infrastructure management platform and the cloud services platform.

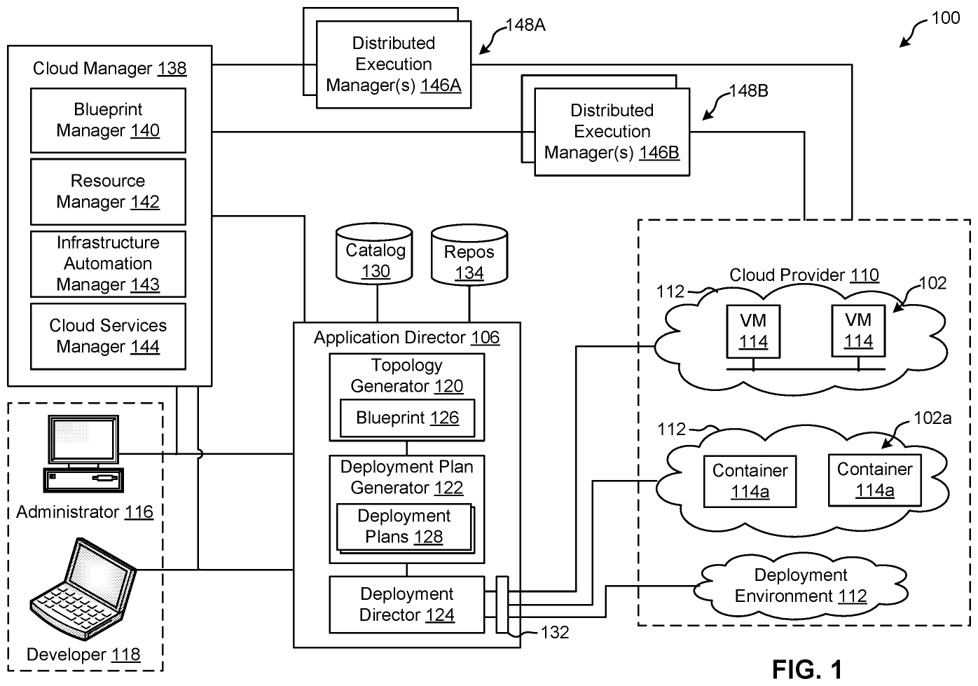

FIG. 1 depicts an example system 100 constructed in accordance with the teachings of this disclosure for managing a cloud computing platform. The example system 100 includes an application director 106 and a cloud manager 138 to manage a cloud computing platform provider 110 as described in more detail below. As described herein, the example system 100 facilitates management of the cloud provider 110 and does not include the cloud provider 110. Alternatively, the system 100 could be included in the cloud provider 110.

The cloud computing platform provider 110 provisions virtual computing resources (e.g., virtual machines, or “VMs,” 114) that may be accessed by users of the cloud computing platform 110 (e.g., users associated with an administrator 116 and/or a developer 118) and/or other programs, software, device. etc.

An example application 102 of FIG. 1 includes multiple VMs 114. The example VMs 114 of FIG. 1 provide different functions within the application 102 (e.g., services, portions of the application 102, etc.). One or more of the VMs 114 of the illustrated example are customized by an administrator 116 and/or a developer 118 of the application 102 relative to a stock or out-of-the-box (e.g., commonly available purchased copy) version of the services and/or application components. Additionally, the services executing on the example VMs 114 may have dependencies on other ones of the VMs 114.

As illustrated in FIG. 1, the example cloud computing platform provider 110 may provide multiple deployment environments 112, for example, for development, testing, staging, and/or production of applications. The administrator 116, the developer 118, other programs, and/or other devices may access services from the cloud computing platform provider 110, for example, via REST (Representational State Transfer) APIs (Application Programming Interface) and/or via any other client-server communication protocol. Example implementations of a REST API for cloud computing services include a vCloud Administrator Center™ (vCAC) and/or vRealize Automation™ (vRA) API and a vCloud Director™ API available from VMware, Inc. The example cloud computing platform provider 110 provisions virtual computing resources (e.g., the VMs 114) to provide the deployment environments 112 in which the administrator 116 and/or the developer 118 can deploy multi-tier application(s). One particular example implementation of a deployment environment that may be used to implement the deployment environments 112 of FIG. 1 is vCloud DataCenter cloud computing services available from VMware, Inc.

In some examples disclosed herein, a lighter-weight virtualization is employed by using containers in place of the VMs 114 in the development environment 112. Example containers 114a are software constructs that run on top of a host operating system without the need for a hypervisor or a separate guest operating system. Unlike virtual machines, the containers 114a do not instantiate their own operating systems. Like virtual machines, the containers 114a are logically separate from one another. Numerous containers can run on a single computer, processor system and/or in the same development environment 112. Also like virtual machines, the containers 114a can execute instances of applications or programs (e.g., an example application 102a) separate from application/program instances executed by the other containers in the same development environment 112.

The example application director 106 of FIG. 1, which may be running in one or more VMs, orchestrates deployment of multi-tier applications onto one of the example deployment environments 112. As illustrated in FIG. 1, the example application director 106 includes a topology generator 120, a deployment plan generator 122, and a deployment director 124.

The example topology generator 120 generates a basic blueprint 126 that specifies a logical topology of an application to be deployed. The example basic blueprint 126 generally captures the structure of an application as a collection of application components executing on virtual computing resources. For example, the basic blueprint 126 generated by the example topology generator 120 for an online store application may specify a web application (e.g., in the form of a Java web application archive or “WAR” file including dynamic web pages, static web pages, Java servlets, Java classes, and/or other property, configuration and/or resources files that make up a Java web application) executing on an application server (e.g., Apache Tomcat application server) that uses a database (e.g., MongoDB) as a data store. As used herein, the term “application” generally refers to a logical deployment unit, including one or more application packages and their dependent middleware and/or operating systems. Applications may be distributed across multiple VMs. Thus, in the example described above, the term “application” refers to the entire online store application, including application server and database components, rather than just the web application itself. In some instances, the application may include the underlying hardware and/or virtual computing hardware utilized to implement the components.

The example basic blueprint 126 of FIG. 1 may be assembled from items (e.g., templates) from a catalog 130, which is a listing of available virtual computing resources (e.g., VMs, networking, storage, etc.) that may be provisioned from the cloud computing platform provider 110 and available application components (e.g., software services, scripts, code components, application-specific packages) that may be installed on the provisioned virtual computing resources. The example catalog 130 may be pre-populated and/or customized by an administrator 116 (e.g., IT (Information Technology) or system administrator) that enters in specifications, configurations, properties, and/or other details about items in the catalog 130. Based on the application, the example blueprints 126 may define one or more dependencies between application components to indicate an installation order of the application components during deployment. For example, since a load balancer usually cannot be configured until a web application is up and running, the developer 118 may specify a dependency from an Apache service to an application code package.

The example deployment plan generator 122 of the example application director 106 of FIG. 1 generates a deployment plan 128 based on the basic blueprint 126 that includes deployment settings for the basic blueprint 126 (e.g., virtual computing resources' cluster size, CPU, memory, networks, etc.) and an execution plan of tasks having a specified order in which virtual computing resources are provisioned and application components are installed, configured, and started. The example deployment plan 128 of FIG. 1 provides an IT administrator with a process-oriented view of the basic blueprint 126 that indicates discrete actions to be performed to deploy the application. Different deployment plans 128 may be generated from a single basic blueprint 126 to test prototypes (e.g., new application versions), to scale up and/or scale down deployments, and/or to deploy the application to different deployment environments 112 (e.g., testing, staging, production). The deployment plan 128 is separated and distributed as local deployment plans having a series of tasks to be executed by the VMs 114 provisioned from the deployment environment 112. Each VM 114 coordinates execution of each task with a centralized deployment module (e.g., the deployment director 124) to ensure that tasks are executed in an order that complies with dependencies specified in the application blueprint 126.

The example deployment director 124 of FIG. 1 executes the deployment plan 128 by communicating with the cloud computing platform provider 110 via a cloud interface 132 to provision and configure the VMs 114 in the deployment environment 112. The example cloud interface 132 of FIG. 1 provides a communication abstraction layer by which the application director 106 may communicate with a heterogeneous mixture of cloud provider 110 and deployment environments 112. The deployment director 124 provides each VM 114 with a series of tasks specific to the receiving VM 114 (herein referred to as a “local deployment plan”). Tasks are executed by the VMs 114 to install, configure, and/or start one or more application components. For example, a task may be a script that, when executed by a VM 114, causes the VM 114 to retrieve and install particular software packages from a central package repository 134. The example deployment director 124 coordinates with the VMs 114 to execute the tasks in an order that observes installation dependencies between VMs 114 according to the deployment plan 128. After the application has been deployed, the application director 106 may be utilized to monitor and/or modify (e.g., scale) the deployment.

The example cloud manager 138 of FIG. 1 interacts with the components of the system 100 (e.g., the application director 106 and the cloud provider 110) to facilitate the management of the resources of the cloud provider 110. The example cloud manager 138 includes a blueprint manager 140 to facilitate the creation and management of multi-machine blueprints and a resource manager 142 to reclaim unused cloud resources. The cloud manager 138 may additionally include other components for managing a cloud environment, such as an infrastructure automation manager 143, a cloud services manager 144, etc.

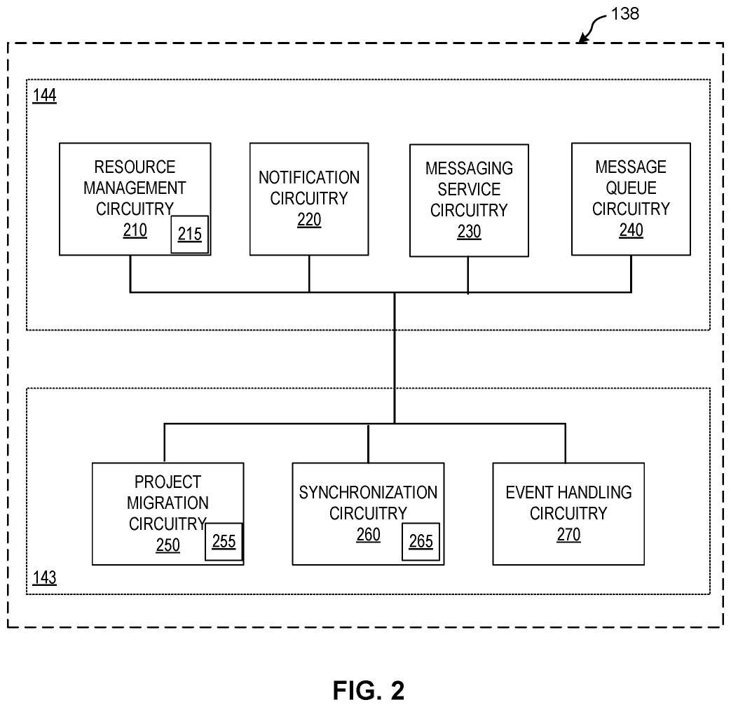

The example blueprint manager 140 of the illustrated example manages the creation of multi-machine blueprints that define the attributes of multiple virtual machines as a single group that can be provisioned, deployed, managed, etc. as a single unit. For example, a multi-machine blueprint may include definitions for multiple basic blueprints that make up a service (e.g., an e-commerce provider that includes web servers, application servers, and database servers). A basic blueprint is a definition of policies (e.g., hardware policies, security policies, network policies, etc.) for a single machine (e.g., a single virtual machine such as a web server virtual machine and/or container). Accordingly, the blueprint manager 140 facilitates more efficient management of multiple virtual machines and/or containers than manually managing (e.g., deploying) basic blueprints individually. Example management of multi-machine blueprints is described in further detail in conjunction with FIG. 2.

The example blueprint manager 140 of FIG. 1 additionally annotates basic blueprints and/or multi-machine blueprints to control how workflows associated with the basic blueprints and/or multi-machine blueprints are executed. As used herein, a workflow is a series of actions and decisions to be executed in a virtual computing platform. The example system 100 includes first and second distributed execution manager(s) (DEM(s)) 146A and 146B to execute workflows. According to the illustrated example, the first DEM 146A includes a first set of characteristics and is physically located at a first location 148A. The second DEM 146B includes a second set of characteristics and is physically located at a second location 148B. The location and characteristics of a DEM may make that DEM more suitable for performing certain workflows. For example, a DEM may include hardware particularly suited for performance of certain tasks (e.g., high-end calculations), may be located in a desired area (e.g., for compliance with local laws that require certain operations to be physically performed within a country's boundaries), may specify a location or distance to other DEMS for selecting a nearby DEM (e.g., for reducing data transmission latency), etc. Thus, the example blueprint manager 140 annotates basic blueprints and/or multi-machine blueprints with capabilities that can be performed by a DEM that is labeled with the same or similar capabilities.

The resource manager 142 of the illustrated example facilitates recovery of cloud computing resources of the cloud provider 110 that are no longer being activity utilized. Automated reclamation may include identification, verification and/or reclamation of unused, underutilized, etc. resources to improve the efficiency of the running cloud infrastructure.

The example infrastructure automation manager 143 enables process automation for tasks in the infrastructure of the cloud provider 110 such as provisioning, configuration, and management of VM(s) 114; provisioning, configuration, and management of container(s) 114a; provisioning, configuration, and management of other resource(s); etc. The infrastructure automation manager 143 provides tools and associated APIs to facilitate interaction, deployment, and management of computing resources in the cloud and/or hybrid cloud infrastructure or environment 112.

The example cloud services manager 144 provides APIs for identity and access management in the cloud and/or hybrid cloud environment. VM(s) 114, container(s) 114a, etc., can also be deployed via the API of the cloud services manager 144, for example.

Both the infrastructure automation manager 143 and the cloud services manager 144 can create projects to identify users that can provision workloads, define resource deployment priority, define resource deployment cloud zone, set a maximum number of allowed deployment instances, restrict access to resources, etc. Using a project, access to resources such as blueprints, infrastructure objects, etc., can be shared between identified users. In certain examples, a project defined by the cloud services manager 144 can be used by the infrastructure automation manager 143. Alternatively or additionally, a project defined by the infrastructure automation manager 143 can be used by the cloud services manager 144.

FIG. 2 is a block diagram of an implementation of the example infrastructure automation manager 143 and the example cloud services manager 144 of the example cloud manager 138 of FIG. 1. The example infrastructure automation manager 143 and the example cloud services manager 144 of FIG. 2 may be instantiated (e.g., creating an instance of, bring into being for any length of time, materialize, implement, etc.) by programmable circuitry such as a central processing unit (CPU) executing first instructions. Additionally or alternatively, the example infrastructure automation manager 143 and the example cloud services manager 144 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

As shown in the example of FIG. 2, the example cloud services manager 144 includes example resource management circuitry 210, example notification circuitry 220, example messaging service circuitry 230, and example message queue circuitry 240. The example infrastructure automation manager 143 includes example project migration circuitry 250, example synchronization circuitry 260, and example event handling circuitry 270.

The example resource management circuitry 210 can, among other things, create a project that is used to coordinate access to resources. The project can be enabled for one or more services across one or more resources for one or more actors, for example. The project is stored in memory circuitry 215. The project is associated with an identifier in the memory circuitry 215.

The example resource management circuitry 210 also receives an indication of a project from the example infrastructure automation manager 143. The resource management circuitry 210 stores an identifier associated with the project in the memory 215. In certain examples, the resource management circuitry 210 stores an indication of the project from the infrastructure automation manager 143 in conjunction with an identifier for the corresponding project of the example cloud services manager 144. The resource management circuitry 210 can also provide an indication of a project to the infrastructure automation manager 143 so that circuitry of the infrastructure automation manager 143 can leverage the project from the memory 215 of the cloud services manager 144, for example.

As such, the resource management circuitry 210 can store a correlation in the memory 215 between corresponding projects of the infrastructure automation manager 143 and the cloud services manager 144. In certain examples, the indication is and/or includes a usage flag and/or other usage indicator alerting the resource management circuitry 210 that a project of the cloud services manager 144 is also being used by the infrastructure automation manager 143. In certain examples, multiple usage flags and/or other indicators can be provided to indicate that the project is in use by the cloud services manager 144 (e.g., a first usage flag) and the infrastructure automation manager 143 (e.g., a second usage flag). As such, the cloud services manager 144 and the infrastructure automation manager 143 can have corresponding projects identified in the memory 215, can utilize the same project stored in the memory 215, etc.

The example notification circuitry 220 serves as a “post office service” to generate and send messages based on events associated with the resource management circuitry 210. An event is an action, request, message, resource allocation, other code execution or data transfer, etc., utilizing the cloud manager 138 and/or other circuitry of the example system 100. For example, the notification circuitry 220 receives an indication of an event such as project creation, project deletion, other event, etc., and publishes a message related to the event. The notification circuitry 220 reads and/or provides messages to the example messaging service circuitry 230 and the example message queue circuitry 240, for example. The example notification circuitry 220 can also send messages to the example infrastructure automation manager 143, for example.

For example, the notification circuitry 220 provides event messages to the messaging service circuitry 230 (e.g., project created, project deleted, resource allocated, resource requested, resource released, etc.). The example notification circuitry 220 can also read events from queues of the message queue circuitry 240, for example. The notification circuitry 220 can process event(s) from the message queue circuitry 240 to form additional message(s) to the messaging service circuitry 230, for example.

As such, the example notification circuitry 220 provides an endpoint for publication of messages (e.g., related to project creation, project deletion, project usage, etc.). The example notification circuitry 220 also polls and reads messages from outgoing queues of the example message queue circuitry 240 and enables delivery of messages to recipients (e.g., subscribers) via the example messaging service circuitry 230, for example.

The example messaging service circuitry 230 receives messages from the example notification circuitry 220. In certain examples, the messaging service circuitry 230 processes a received message according to a message type (e.g., included in a field of the message). The example messaging service circuitry 230 interacts with the example notification circuitry 220 and the example message queue circuitry 240 to send and receive messages related to events in the example cloud services manager 144.

The example message queue circuitry 240 hosts one or more outgoing queues for messages associated with one or more subscribers/recipients. Each subscriber has a queue in the message queue circuitry 240, for example. When a subscription is made for a subscriber to a certain message type, the respective queue is configured to receive messages for the message type or topic, for example.

The example project migration circuitry 250 can create a project for the example infrastructure automation manager 143. The example project migration circuitry 250 can store the project in a memory 255. The example project migration circuitry 250 can provide the project to the example resource management circuitry 210, which stores the project in the memory 215 and/or sets a usage flag and/or other indicator for the associated project stored in the memory 215, for example.

In certain examples, the project migration circuitry 250 migrates projects from the infrastructure automation manager 143 to the cloud services manager 144. The project migration circuitry 250 can provide projects to the memory 215 periodically, on request, on demand, based on a trigger event, etc., and/or otherwise trigger the resource management circuitry 210 to create, update, etc., one or more projects in the memory 215 based on usage by the infrastructure automation manager 143. The project migration circuitry 250 helps to ensure that the resource management circuitry 210 has created and stored a usage flag and/or other indicator for the corresponding project in the memory 215, for example.

The example synchronization circuitry 260 synchronizes projects between the cloud services manager 144 and the infrastructure automation manager 143. The example synchronization circuitry 260 reads projects from the resource management circuitry 210, for example. The synchronization circuitry 260 can store project information in a memory 265, for example. The example synchronization circuitry 260 retrieves (e.g., periodically, on request, on demand, based on a trigger event, etc.) projects from the memory 215 and creates corresponding projects in the memory 265. The example synchronization circuitry 260 can communicate with the example project migration circuitry 250 to coordinate projects in the memories 255, 265, for example. When a project is deleted from the memory 215, the synchronization circuitry 260 deletes the project from the memory 265, for example.

The example event handling circuitry 270 handles (e.g., processes) events for the example infrastructure automation manager 143. For example, the event handling circuitry 270 can receive an event in a message from the example notification circuitry 220. The event handling circuitry 270 parses the message to identify the event and then processes the event. For example, project creation and project deletion events can be received and processed by the example event handling circuitry 270.

In certain examples, event handling (e.g., processing) can vary based on state. For example, a project may be in use and/or otherwise have resources allocated to the project. Alternatively, no resources may be allocated to the project. Upon receipt of a delete event (e.g., a delete instruction, a delete request, etc.), for example, the delete event for a project can be treated differently depending on whether resources are currently allocated for the project.

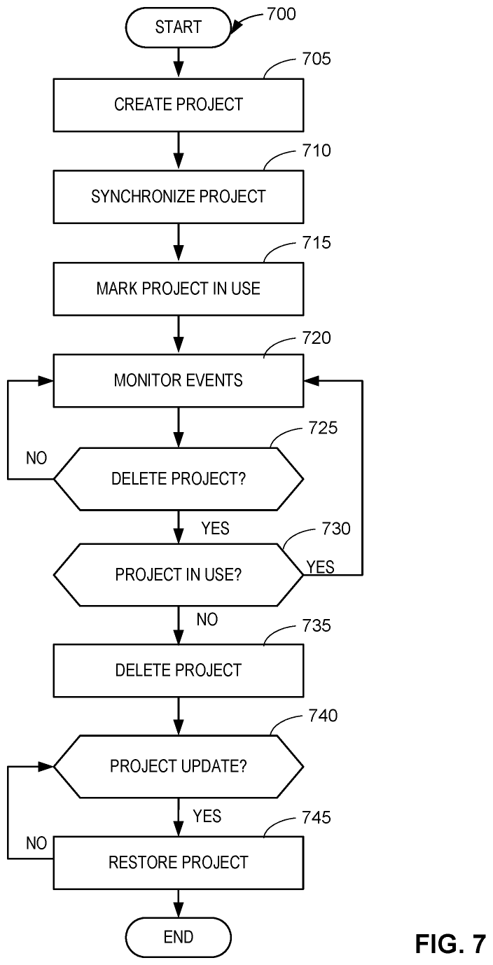

In some examples, the resource management circuitry 210 is instantiated by programmable circuitry executing resource management instructions and/or configured to perform operations such as those represented by the flowchart(s) of FIG. 7. In some examples, the notification circuitry 220 is instantiated by programmable circuitry executing notification instructions and/or configured to perform operations such as those represented by the flowchart(s) of FIG. 7. In some examples, the messaging service circuitry 230 is instantiated by programmable circuitry executing messaging service instructions and/or configured to perform operations such as those represented by the flowchart(s) of FIG. 7. In some examples, the message queue circuitry 240 is instantiated by programmable circuitry executing message queue instructions and/or configured to perform operations such as those represented by the flowchart(s) of FIG. 7. In some examples, the project migration circuitry 250 is instantiated by programmable circuitry executing project migration instructions and/or configured to perform operations such as those represented by the flowchart(s) of FIG. 7. In some examples, the synchronization circuitry 260 is instantiated by programmable circuitry executing synchronization instructions and/or configured to perform operations such as those represented by the flowchart(s) of FIG. 7. In some examples, the event handling circuitry 270 is instantiated by programmable circuitry executing event handling instructions and/or configured to perform operations such as those represented by the flowchart(s) of FIG. 7.

In some examples, the apparatus includes means for monitoring. The means for monitoring can be implemented by the infrastructure automation manager 143 and/or the cloud services manager 144, for example. In certain examples, the means for monitoring monitors first events and second events. In some examples, one of the infrastructure automation manager 143 and/or the cloud services manager 144 monitors for first events and the other of the infrastructure automation manager 143 and/or the cloud services manager 144 monitors for second events. For example, the resource management circuitry 150 and/or the project migration circuitry 250, alone or in conjunction with the synchronization circuitry 260 and/or the event handling circuitry 270, can implement the means for monitoring.

In some examples, the apparatus includes means for managing a record stored for a project. The means for managing can be implemented by the infrastructure automation manager 143 and/or the cloud services manager 144, for example. For example, the resource management circuitry 150 and/or the project migration circuitry 250 can implement the means for managing.

In some examples, the apparatus includes means for deleting a project. The means for deleting can be implemented by the infrastructure automation manager 143 and/or the cloud services manager 144, for example. For example, the resource management circuitry 150 and/or the project migration circuitry 250 can implement the means for deleting.

In some examples, the apparatus can include means for restoring the project. The means for restoring can be implemented by the infrastructure automation manager 143 and/or the cloud services manager 144, for example. For example, the resource management circuitry 150 and/or the project migration circuitry 250 can implement the means for restoring.

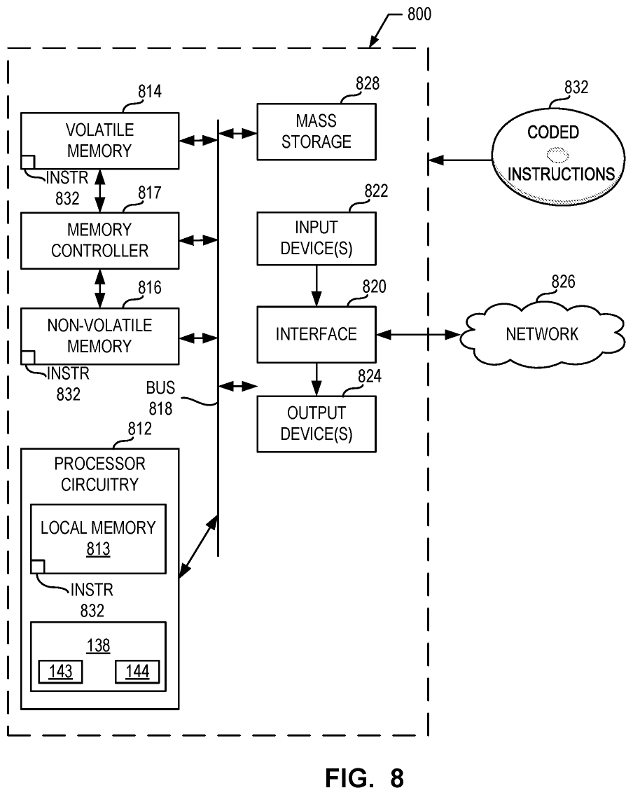

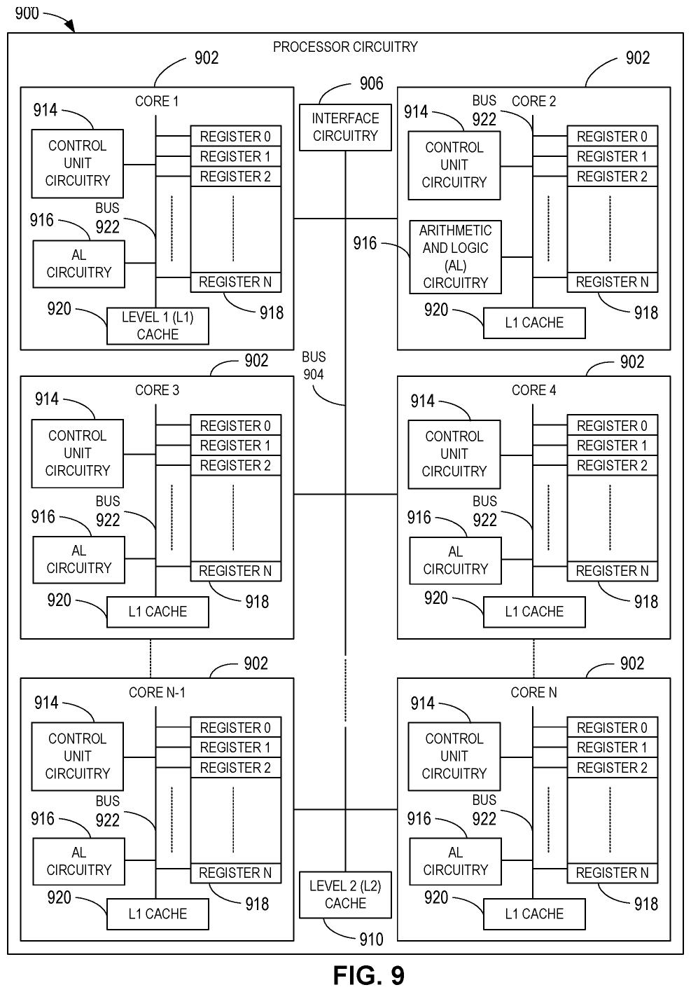

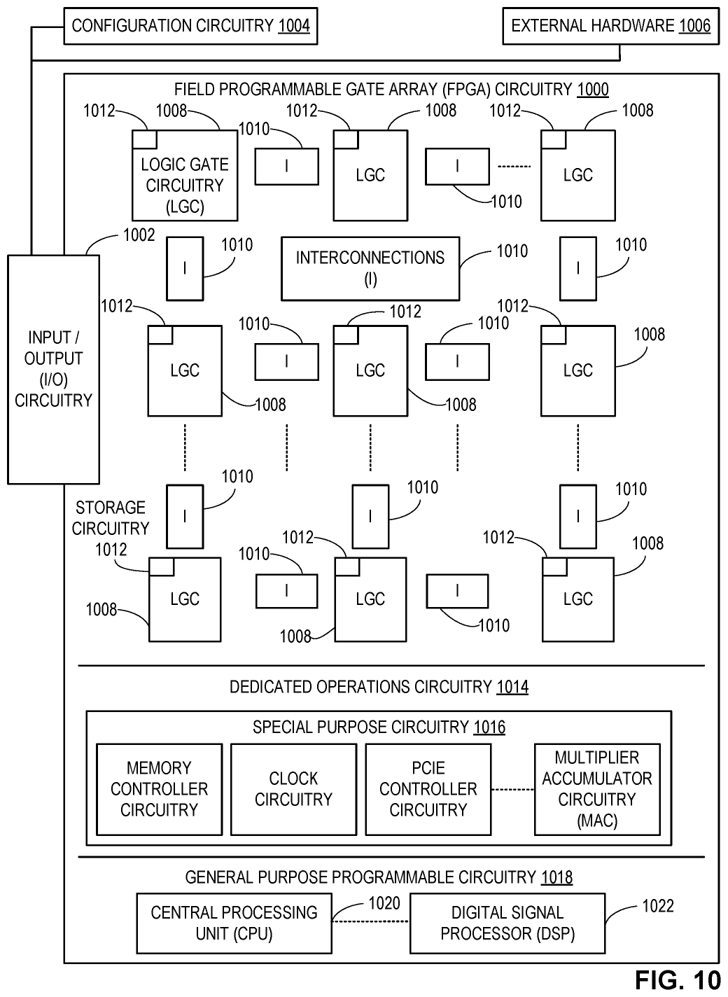

In some examples, the infrastructure automation manager 143 and/or the cloud services manager 144, and/or the elements of the infrastructure automation manager 143 and/or the cloud services manager 144, such as the resource management circuitry 150, the project migration circuitry, the synchronization circuitry 260, the event handling circuitry 270, etc., may be instantiated by programmable circuitry such as the example programmable circuitry 812 of FIG. 8. For instance, the infrastructure automation manager 143 and/or the cloud services manager 144, and/or the elements of the infrastructure automation manager 143 and/or the cloud services manager 144, such as the resource management circuitry 150, the project migration circuitry, the synchronization circuitry 260, the event handling circuitry 270, etc., may be instantiated by the example microprocessor 900 of FIG. 9 executing machine executable instructions such as those implemented by at least blocks 705-745 of FIG. 7. In some examples, the infrastructure automation manager 143 and/or the cloud services manager 144, and/or the elements of the infrastructure automation manager 143 and/or the cloud services manager 144, such as the resource management circuitry 150, the project migration circuitry, the synchronization circuitry 260, the event handling circuitry 270, etc., may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the infrastructure automation manager 143 and/or the cloud services manager 144, and/or the elements of the infrastructure automation manager 143 and/or the cloud services manager 144, such as the resource management circuitry 150, the project migration circuitry, the synchronization circuitry 260, the event handling circuitry 270, etc., may be instantiated by any other combination of hardware, software, and/or firmware. For example, the infrastructure automation manager 143 and/or the cloud services manager 144, and/or the elements of the infrastructure automation manager 143 and/or the cloud services manager 144, such as the resource management circuitry 150, the project migration circuitry, the synchronization circuitry 260, the event handling circuitry 270, etc., may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

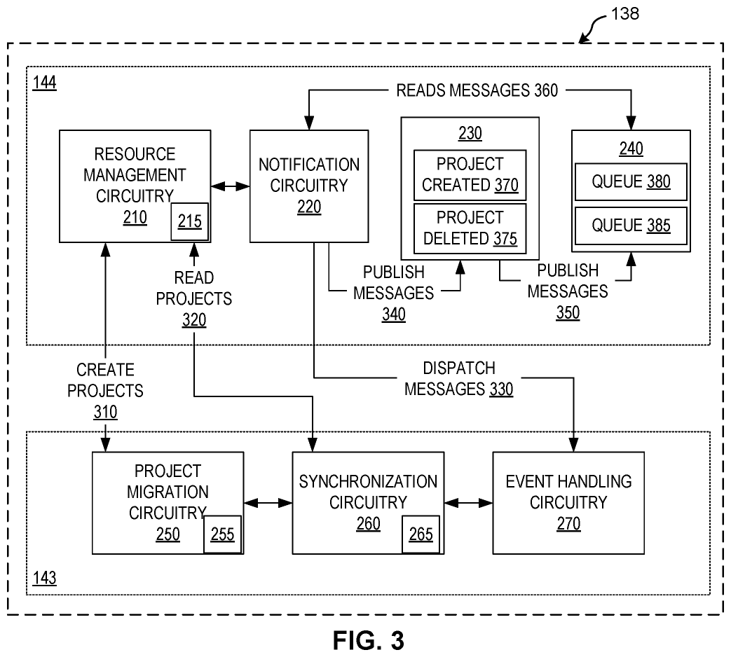

FIG. 3 shows an example configuration and message exchange of the infrastructure automation manager 143 and the cloud services manager 144 for project management. As shown in the example of FIG. 3, the example infrastructure automation manager 143 and the example cloud services manager 144 provide asynchronous processing of projects, associated events, and resulting messages. In the example of FIG. 3, the infrastructure automation manager 143 and the cloud services manager 144 can exchange instructions 310, 320 and messages 330-350.

The example project migration circuitry 250 generates an instruction 310 for the example resource management circuitry 210 to create a project. In response to the instruction 310, the resource management circuitry 210 stores the project in the memory 215 and/or updates a usage flag for an existing project in the memory 215 to indicate usage of the existing project by the infrastructure automation manager 143.

The example synchronization circuitry 260 sends an instruction 320 to read a project from the memory 215 of the resource management circuitry 210. The synchronization circuitry 260 can synchronize the project (e.g., a status of the project such as project usage by the cloud services manager 144 and the infrastructure automation manager 143, etc.) with the memory 265.

The example notification circuitry 220 dispatches a message 330 to the example event handling circuitry 270 including an event, such as a project creation, a project deletion, etc. The event handling circuitry 270 processes a payload of the message 330 including the event. For example, the event handling circuitry 270 interacts with the synchronization circuitry 260 to synchronize project status including creating a project and managing deletion of a project that remains in use by one or more of the infrastructure automation manager 143 and the cloud services manager 144.

The notification circuitry 220 also publishes a message 340 to the example messaging service circuitry 230. The messaging service circuitry 230 organizes messages according to topic such as project created 370, project deleted 375, etc. The messaging service circuitry 230 publishes a message 350 to the example message queue circuitry 240 according to the topic of the received message 340. The message 350 is routed to a queue 380, 385 based on the topic. For example, a queue 380 subscribing to and/or otherwise associated with the project deleted 375 topic receives the message 350 related to deletion of the associated project. A queue 385 subscribing to and/or otherwise associated with the project created 370 receives the message 350 related to creation of the associated project, for example. The notification circuitry 220 can read a message 360 from the message queue circuitry 240 regarding an update to one or more of the queues 380, 385, for example.

As such, the infrastructure automation manager 143 and the cloud services manager 144 can exchange instructions 310-320 and messages 330-360 to track and manage project status. The infrastructure automation manager 143 and the cloud services manager 144 can be informed regarding project creation, project deletion, and project usage to help ensure that usage and deletion of projects is coordinated. Such coordination allows users and resources of the infrastructure automation manager 143 and the cloud services manager 144 to share projects and provide updates to shared projects. Upon a request or other instruction to delete a project by one or both of the infrastructure information manager 143 and the cloud services manager 144, usage of the project by the infrastructure automation manager 143 and the cloud services manager 144 is determined so that a project is not deleted by a request of one of the infrastructure automation manager 143 and the cloud services manager 144 while the other of the infrastructure automation manager 143 and the cloud services manager 144 is still using the project. This coordination allows sharing of projects and associated configuration, resources, etc., while avoiding errors from deletion of a project that is in use, for example.

As such, when a project is created by the resource management circuitry 210 (e.g., through an application programming interface (API) associated with the cloud resource manager 144), the notification circuitry 220 publishes an event corresponding to project creation. When the project is deleted (e.g., by a delete instruction provided through the API, etc.), the notification circuitry 220 publishes an event corresponding to project deletion. Each message 340 corresponding to a respective event is sent to a different message or event type 370, 375 in the messaging service circuitry 230. The messaging service circuitry 230 dispatches the events 370, 375 to different subscriber queues 380, 385 of the message queue circuitry 240. However, the order of message 350 in the queues 380, 385 may not be guaranteed, potentially resulting in an uncertain order of delivery. As such, events can persist in the queues 380, 385 to be handled individually, batched and handled as a group, etc.

Projects can be created, updated, and/or deleted synchronously and/or asynchronously with respect to the infrastructure automation manager 143 and the cloud resource manager 144. When changes to a project are done synchronously between the infrastructure automation manager 143 and the cloud resource manager 144, both managers 143 are aware of the state and changes to the project. However, when changes to a project are asynchronous, one or both of the infrastructure automation manager 143 and the cloud resource manager 144 may be unaware of a change and/or operating on outdated project information. In certain examples, a project may be updated by the cloud resource manager 144 while the infrastructure automation manager 143 is separately being updated via a user interface based on stale project data (from prior to the update by the cloud resource manager 144). To help prevent inconsistent, conflicting, and/or otherwise erroneous project state or status, the project can be locked in the memory 215, 255, and/or 265. Alternatively or additionally, project status can be merged across the memories 215, 255, and/or 265. In certain examples, one project status can control over another project status.

While an example manner of implementing the infrastructure automation manager 143 of FIG. 1 is illustrated in FIG. 2, one or more of the elements, processes, and/or devices illustrated in FIG. 2 may be combined, divided, re-arranged, omitted, eliminated, and/or implemented in any other way. Further, the example project migration circuitry 250, the example synchronization circuitry 260, the example event handling circuitry 270, and/or, more generally, the example infrastructure automation manager 143 of FIG. 1, may be implemented by hardware alone or by hardware in combination with software and/or firmware. Thus, for example, any of the example project migration circuitry 250, the example synchronization circuitry 260, the example event handling circuitry 270, and/or, more generally, the example infrastructure automation manager 143, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example infrastructure automation manager 143 of FIG. 1 may include one or more elements, processes, and/or devices in addition to, or instead of, those illustrated in FIG. 2, and/or may include more than one of any or all of the illustrated elements, processes and devices.

Similarly, while an example manner of implementing the cloud resource manager 144 of FIG. 1 is illustrated in FIG. 2, one or more of the elements, processes, and/or devices illustrated in FIG. 2 may be combined, divided, re-arranged, omitted, eliminated, and/or implemented in any other way. Further, the example resource management circuitry 210, the example notification circuitry 220, the example messaging service circuitry 230, the example message queue service 240, and/or, more generally, the example cloud resource manager 144 of FIG. 1, may be implemented by hardware alone or by hardware in combination with software and/or firmware. Thus, for example, any of the example resource management circuitry 210, the example notification circuitry 220, the example messaging service circuitry 230, the example message queue service 240, and/or, more generally, the example cloud resource manager 144, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example cloud resource manager 144 of FIG. 1 may include one or more elements, processes, and/or devices in addition to, or instead of, those illustrated in FIG. 2, and/or may include more than one of any or all of the illustrated elements, processes and devices.

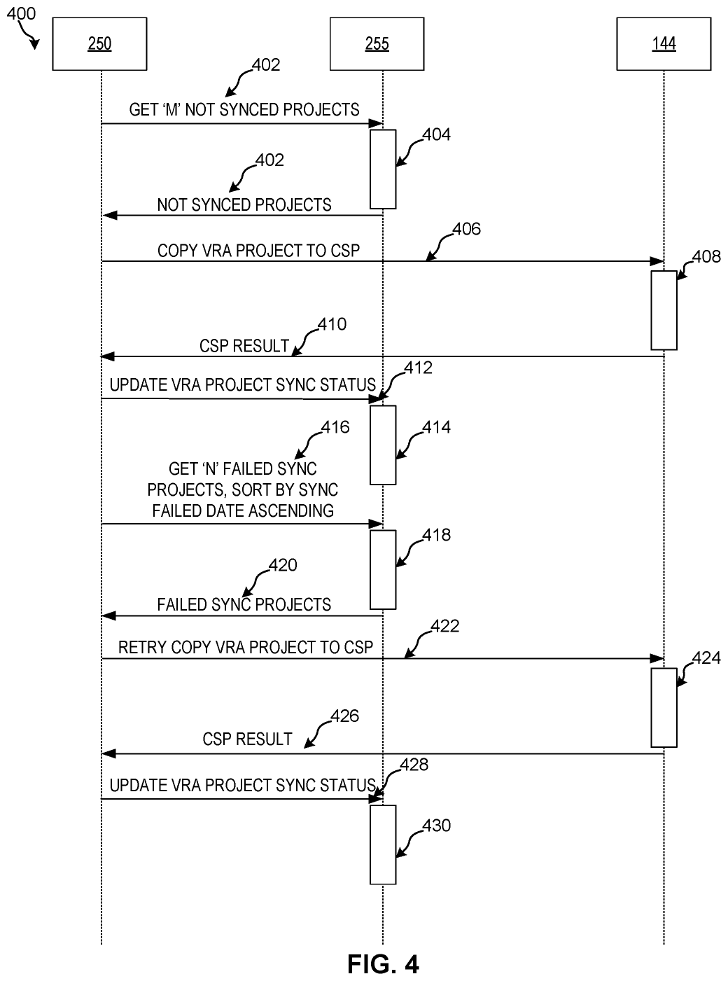

FIG. 4 is an illustration of a control flow 400 including an example exchange of instructions and data between the example project migration circuitry 250, the example memory circuitry 255, and the example cloud services manager 144. At 402, the project migration circuitry 250 identifies and requests (e.g., “gets”) a number of projects stored in the memory circuitry 255 that are not labeled as synchronized with the cloud services manager 144. For example, the memory circuitry 255 stores projects, and the projects may be known to the cloud services manager 144 and/or otherwise flagged, tagged, or marked as synchronized, unsynchronized, etc. If projects are marked as unsynchronized, not marked as synchronized, marked as new, etc., such projects represent a subset of projects to be synchronized and managed jointly between the cloud services manager 144 and the infrastructure automation manager 143, for example. At 404, the memory circuitry 255 returns the unsynchronized projects to the project migration circuitry 250. For example, a project A is identified as unsynchronized.

At 406, the projection migration circuitry 250 copies an unsynchronized project to the cloud services manager 144. For example, the project A is copied to the cloud services manager 144 for further processing. At 408, the cloud services manager 144 synchronizes the project. For example, the cloud services manager 144 synchronizes project A between the cloud services manager 144 and the infrastructure automation manager 143, and the infrastructure automation manager 143 maintains the status of project A (e.g., marking project A as synchronized).

At 410, the cloud services manager 144 provides a result of the project synchronization to the project migration circuitry 250. For example, the cloud services manager 144 updates the project migration circuitry 250 to indicate that project A has been synchronized.

At 412, the project migration circuitry 250 updates the memory circuitry 255 with a status of project synchronization between the cloud services manager 144 and the infrastructure automation manager 143. For example, the project migration circuitry 250 stores an indication that project A is synchronized in the memory circuitry 255. At 414, the memory circuitry 255 stores the project synchronization updates/status. For example, the memory circuitry 255 stores an indication that project A is synchronized.

At 416, the project migration circuitry 250 requests an identification of failed project synchronization(s) from the memory circuitry 255. At 418, the memory circuitry 255 retrieves failed project synchronization(s), and, at 420, provides an identification of failed project synchronization(s) to the project migration circuitry 250. For example, if project B was not synchronized, then the memory circuitry 255 identifies project B as a failed project synchronization to the project migration circuitry 250.

At 422, the project migration circuitry 250 retries to synchronize failed project synchronization request(s) with the cloud services manager 144. For example, the project migration circuitry 250 identifies project B to the cloud services manager 144 for synchronization. At 424, the cloud services manager 144 synchronizes the identified project(s). for example, the cloud services manager 144 synchronizes project B from the project migration circuitry 250 of the infrastructure automation manager 143.

At 426, the cloud services manager 144 sends a result of the synchronization to the project migration circuitry 250. For example, the cloud services manager 144 provides an acknowledgement and indication of successful synchronization of project B to the project migration circuitry 250. At 428, the project migration circuitry 250 updates the project synchronization status in the memory circuitry 255. For example, the project migration circuitry 250 updates a record in the memory circuitry 255 to indicate that project B is now synchronized. At 430, the memory circuitry 255 updates the corresponding record, entry, table, other data structure, etc.

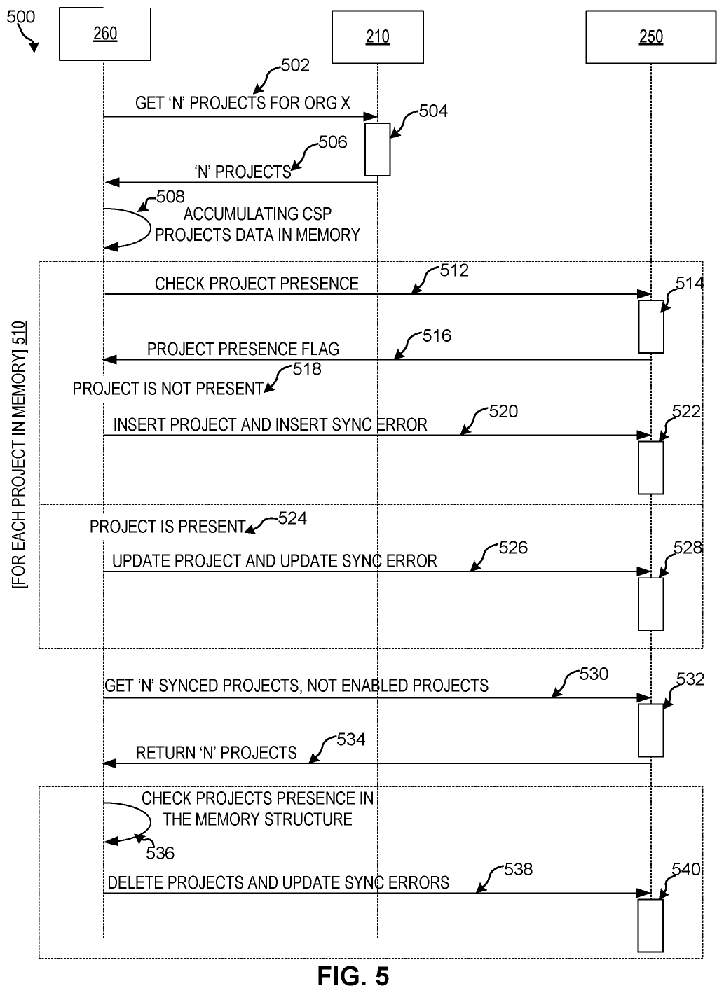

FIG. 5 is an illustration of a control flow 500 including an example exchange of instructions and data between the example synchronization circuitry 260, the example resource management circuitry 210, and a services layer or API of the project migration circuitry 250. At 502, the synchronization circuitry 260 requests projects for an organization. For example, the synchronization circuitry 260 requests N projects associated with organization X from the resource management circuitry 210. As such, all projects for an organization can be requested from the cloud services manger 144 in parallel, for example. At 504, the resource management circuitry 210 retrieves the requested projects. For example, the resource management circuitry 210 retrieves N projects associated with organization X from the memory circuitry 215. At 506, the projects (or an identification of the projects) are returned to the synchronization circuitry 260.

At 508, data associated with the projects is accumulated in memory by the synchronization circuitry 260. For example, data associated with each of N projects for organization X is accumulated. At 510, the synchronization circuitry 260 processes each project in memory. For example, the synchronization circuitry 260 analyzes the data for each of N projects. At 512, the synchronization circuitry 260 interacts with the project migration circuitry 250 to determine whether a particular project is still present. For example, the synchronization circuitry 260 queries the project migration circuitry 250 to determine, at 514, whether a given project of the N projects still exists in the memory circuitry 255. At 516, the project migration circuitry 250 returns a flag and/or other indicator indicating whether or not the project is present. The control and data flow then proceeds differently depending on whether the project is present in the memory circuitry 255 of the infrastructure automation manager 143.

At 518, when the project is not present in the infrastructure automation manager 143, the synchronization circuitry 260 inserts, at 520, the project, as well as an indication of synchronization error, in the project migration circuitry 250. For example, the synchronization circuitry 260 inserts the project in the memory circuitry 255 with the project migration circuitry 250. The synchronization also indicates that a synchronization error has occurred because the project from the cloud services manager 144 was not found at the infrastructure automation manager 143. At 522, the project is added to the memory circuitry 255 by the project migration circuitry 250.

At 524, when the project is present in the infrastructure automation manager 143, the synchronization circuitry 260, at 526, updates the project via the project migration circuitry 250 and updates an associated synchronization error. For example, the synchronization circuitry 260 provides an update to the project migration circuitry 250 to update the project stored in the memory circuitry 255. Additionally, if the project had a synchronization error, that error (e.g., and an associate flag or status indicator, etc.) can be removed. At 528, the project migration circuitry 250 updates the project and associated flag in the memory circuitry 255.

At 530, the synchronization circuitry 260 requests N synchronized projects from the infrastructure automation manager 143. At 532, the project migration circuitry 250 retrieves the requested N synchronized projects from the memory circuitry 255, and, at 534, provides the N synchronized projects to the synchronization circuitry 260. At 536, the synchronization circuitry 260 compares the retrieved projects from the cloud services manager 144 (via the resource management circuitry 210) with the retrieved projects from the infrastructure automation manager 143 (via the project migration circuitry 250) to identify any mismatch. As such, the synchronization circuitry 260 can determine whether a project from the infrastructure automation manager 143 has already been deleted at the cloud services manager 144. At 538, the synchronization circuitry 260 deletes project(s) from the project migration circuitry 250 that were not found in the cloud services manager 144 and updates associated synchronization error(s). For example, the synchronization circuitry 260 removes projects from the memory circuitry 255 of the infrastructure automation manager 143 and removes or otherwise updates associated synchronization errors with the cloud services manager 144 (e.g., via the resource management circuitry 210). At 540, the project migration circuitry 250 updates its memory circuitry 255 based on the removal of project(s).

As such, projects can be managed between the infrastructure automation manager 143 and the cloud services manager 144. Projects that have never been synchronized can be synchronized from the infrastructure automation manager 143 to the cloud services manager 144. After an initial synchronization attempt, a flag or status is set to failed if the corresponding project does not exist. If projects have been successfully synchronized, then that status and associated correlation can be noted, maintained, and used by the infrastructure automation manager 143 and the cloud services manager 144, for example. Additionally, while described above as synchronizing from the infrastructure automation manager 143 to the cloud services manager 144, other examples can include the reverse-synchronizing projects from the cloud services manager 144 to the infrastructure automation manager 143.

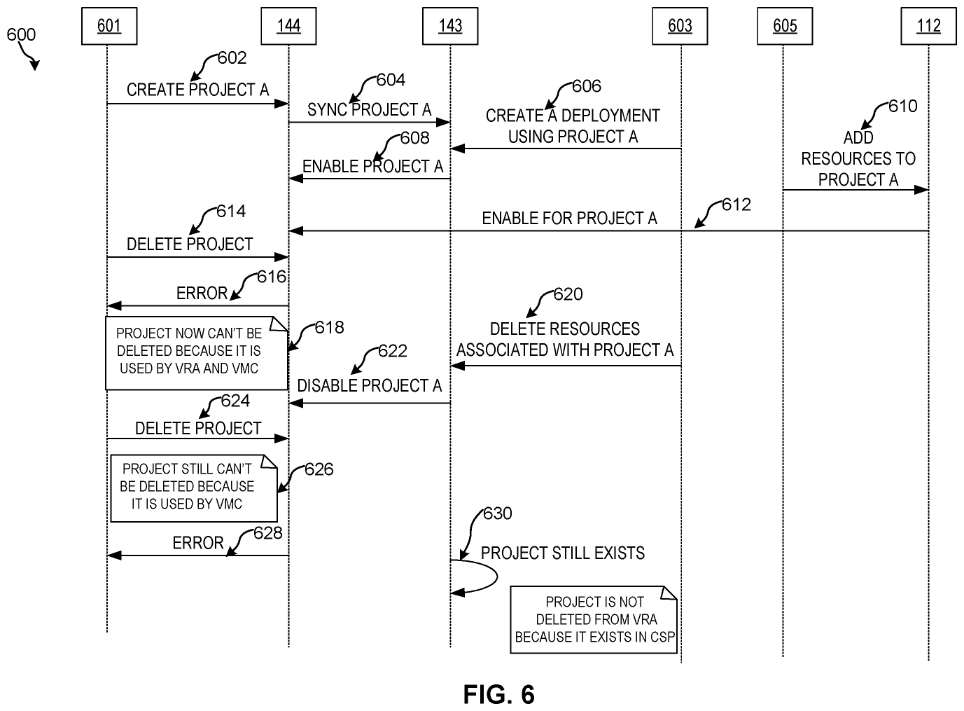

FIG. 6 is an illustration of a control flow 600 including an example exchange of instructions and data between the example cloud services manager 144, the example infrastructure automation manager 143, and the example deployment environment 112 (e.g., cloud, server, etc.). In the example of FIG. 6, projects are managed according to use by the infrastructure automation manager 143 and/or the cloud services manager 144. At 602, a project administrator 601 instructs the cloud services manager 144 to create project A. Then, at 604, the cloud services manager 144 synchronizes project A with the infrastructure automation manager 143. As such, both the cloud services manager 144 and the infrastructure automation manager 143 have a record of project A. At 606, a user 603 (e.g., a computer, virtual machine, container, process, processor, etc.) can then create a deployment from the infrastructure automation manager 143 using project A. At 608, the infrastructure automation manager 143 enables the deployment of project A with the cloud services manager 144. For example, project A is flagged as “in use,” active, etc., with both the infrastructure automation manager 143 and the cloud services manager 144.

At 610, a cloud administrator 605 adds resource(s) to the deployment environment 112 for project A. For example, the administrator 605 instantiates a container, virtual machine, etc., to the cloud for use with project A. The deployment environment 112 then, at 612, informs the cloud services manager 144 to enable the deployment environment 112 (e.g., the cloud, a server, etc.) for use with project A.

At 614, the project administrator 601 requests deletion of project A. For example, the project administrator 601 sends a delete instruction to the cloud services manager 144. At 616, the cloud services manager 144 returns an error to the project administrator 601 because project A is flagged as being used, active, etc. The cloud services manager 144 can generate a message 618 informing the project administrator 601 that project A cannot be deleted (e.g., the delete instruction or request is denied) because it is in use by both the infrastructure automation manager 143 and the cloud services manager 144.

At 620, the user 603 instructs the infrastructure automation manager 143 to delete resources associated with project A. At 622, the infrastructure automation manager 143 instructs the cloud services manager 144 to disable project A. However, project A is still in use by the deployment environment 112. At 624, the project administrator 601 again requests deletion of project A with the cloud services manager 144. However, project A is still in use by the deployment environment 112 and cannot yet be deleted. The cloud services manager 144 sends a message 626 with an error 628 to the project administrator 601 indicating that project A is still in use. At 630, the infrastructure automation manager 143 denies the delete request and maintains project A because project A is still in use by the cloud services manager 144 and associated deployment environment 112. The infrastructure automation manager 143 can continue to check the status of project A with the cloud services manager 144 and delete project A once the cloud services manager 144 is no longer using project A in the deployment environment 112.

As such, the infrastructure automation manager 143 and the cloud services manager 144 work together to monitor use of resources related to project A. For example, when a Cloud Zone is assigned, a Blueprint is created, a CodeStream pipeline is created, project A can be checked to confirm its use and mark it as used in the memory circuitry 215, 255. Once a resource is removed, use of project A can similarly be checked to determine whether no resource associated with project A remains, at which point project A can be deleted.

Alternatively or additionally, rather than hooking into or otherwise connecting with resources, the infrastructure automation manager 143 can periodically check (e.g., every 5 minutes, 10 minutes, 15 minutes, 30 minutes, etc.) to see whether project A is in use. Action can then be taken to maintain project A or delete project A.

Alternatively or additionally, the user 603 can control whether project A is maintained or is deleted. As such, the user 603 can mark project A as used or not used, and the infrastructure automation manager 143 and/or the cloud services manager 144 maintain or delete project A based on the user marking.

Alternatively or additionally, the infrastructure automation manager 143 can periodically check (e.g., every 5 minutes, 10 minutes, 15 minutes, 30 minutes, etc.) to see whether project A is in use. If project A is in use, then the infrastructure automation manager 143 marks project A as in use. If project A is not in use, then the infrastructure automation manager 143 marks project A as not in use. However, the infrastructure automation manager 143 and the cloud services manager 144 can also react to an inconsistent state of project A. For example, resource(s) may be allocated to project A, but project A is not yet marked as used. The cloud services manager 144 can delete project A and notify the infrastructure automation manager 143 that project A has been deleted. The infrastructure automation manager 143 triggers a periodic monitoring task to check that project A has resources. If project A still has resources allocated to it, the infrastructure automation manager 143 can instruct the cloud services manager 144 to recreate project A.

In another inconsistent state, resources for project A have been removed, but project A is still marked as in use, rather than not in use. Project A cannot be deleted by the cloud services manager 144, but the infrastructure automation manager 143 can confirm that no resources are in use for project A. Project A can then be deleted via the infrastructure automation manager 143 and/or the cloud services manager 144.

As such, certain examples monitor resource usage in comparison with project status to determine whether or not a project is truly in use and either delete or recreate that project to maintain consistency between the infrastructure automation manager 143 and the cloud services manager 144.

A flowchart representative of example machine readable instructions, which may be executed to configure processor circuitry to implement the example infrastructure automation manager 143 and/or the example cloud services manager 144 of FIG. 2, is shown in FIG. 7. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 7, many other methods of implementing the example infrastructure automation manager 143 and/or the example cloud services manager 144 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

FIG. 7 is a flowchart representative of example machine readable instructions and/or example operations 700 that may be executed and/or instantiated by processor circuitry to implement the cloud manager 138, or more specifically, the infrastructure automation manager 143 and/or the cloud services manager 144 of the cloud manager 138, and/or facilitate interaction between the infrastructure automation manager 143 and the cloud services manager 144 to manage a project. The machine readable instructions and/or the operations 700 of FIG. 7 begin at block 705, at which a project is created. The project can be created by the infrastructure automation manager 143 or by the cloud services manager 144 to organize resources and regulate access. At block 710, the project is synchronized. For example, the project was created by one of the infrastructure automation manager 143 or the cloud services manager 144. The project is then synchronized with the other of the infrastructure automation manager 143 or the cloud services manager 144. As such, both the infrastructure automation manager 143 and the cloud services manager 144 include a record of the project.

At block 715, the project is marked as in use. For example, the infrastructure automation manager 143 and the cloud services manager 144 mark a record stored in the memory circuitry 215, 255 associated with the project to indicate that the project is “in use” or active.

At block 720, the infrastructure automation manager 143 and/or the cloud services manager 144 monitor events occurring with respect to the project. For example, events such as resource allocation, resource deallocation, blueprint creation, etc., are monitored by the infrastructure automation manager 143 and/or the cloud services manager 144 to evaluate an impact or relation of the event to the project.

At block 725, the event is evaluated to determine whether the event includes or is associated with an instruction or other indication to delete the project. For example, a resource deallocation may include a request to delete the project. An instruction to delete the project may be sent separate from the event as well (or may constitute its own event).

If there is no request to delete the project, then control reverts to block 720 to monitor events. If there is a request to delete the project, then, at block 730, the project is evaluated to determine whether the project is in use. For example, a record stored in the memory circuitry 215 and/or 255 can be examined to determine whether the project is present and whether the project is marked as in use/active or not in use/inactive, etc.

If the project is in use, then the project is not removed, and control reverts to block 720 to monitor events. If the project is not in use or otherwise inactive, then, at block 735, the project is deleted. For example, a record associated with the project in the memory circuitry 215 and/or 255 can be removed.

At block 740, events are monitored to identify an update or other reference to the deleted project. For example, resource allocation, usage, etc., can be monitored by the infrastructure automation manager 143 and/or the cloud services manager 144 to detect a reference to the deleted project. In some examples, the infrastructure automation manager 143 monitors for resource allocation related to the deleted project.

If a reference to the deleted project is identified, then, at block 745, the project is restored. For example, if an application execution, resource allocation, other event, etc., references the deleted project, that reference is an indication that the project should not have been deleted (e.g., because it still has allocated resources and/or is associated with an ongoing deployment, installation, execution, etc.). The infrastructure automation manager 143 and/or the cloud services manager 144 maintains a record or other reference of the deleted project so that the project can be restored in one or both of the memory circuitry 215, 255 when reference to the deleted project is detected. For example, the infrastructure automation manager 143 monitors for resource allocation related to the deleted project and initiates project restoration at the cloud services manager 144 to restore reference to the project in the memory circuitry 215. The project may not have been deleted from the infrastructure automation manager 143 because the infrastructure automation manager 143 has allocated resources to the project.

As such, projects can be created, managed, maintained, deleted, and restored. When a project appears to be no longer in use, that project can be deleted. However, a reference to that deleted project can be maintained in case the project was accidentally deleted and remains still in use. In such case, the project can be restored at one or both of the infrastructure automation manager 143 and/or the cloud services manager 144. Project synchronization, monitoring, update, deletion, and restoration as reflected in the example control flows of FIGS. 4-6 for example project A can proceed as illustrated according to the instructions 700 of FIG. 7 described above.

FIG. 8 is a block diagram of an example programmable circuitry platform 800 structured to execute and/or instantiate the example machine-readable instructions and/or the example operations of FIG. 7 to implement the cloud manager 138 of FIGS. 1-3. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example cloud manager 138 (and/or its infrastructure automation manager 143 and/or cloud services manager 144). In certain examples, one instantiation of the programmable circuitry platform 800 implements the infrastructure automation manager 143 and another instantiation of the programmable circuitry platform 800 implements the cloud services manager 144.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIG. 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowchart of FIG. 7 to effectively instantiate the circuitry of FIG. 2 as logic circuits to perform operations corresponding to those machine readable instructions. In some such examples, the circuitry of FIGS. 1-3 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIG. 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIG. 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 7. As such, the FPGA circuitry 1000 may be configured and/or structured to effectively instantiate some or all of the operations/functions corresponding to the machine readable instructions of the flowchart(s) of FIG. 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIG. 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIG. 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIG. 7 to perform first operation(s)/function(s), the FPGA circuitry 1000 of FIG. 10 may be configured and/or structured to perform second operation(s)/function(s) corresponding to a second portion of the machine readable instructions represented by the flowchart of FIG. 7, and/or an ASIC may be configured and/or structured to perform third operation(s)/function(s) corresponding to a third portion of the machine readable instructions represented by the flowchart of FIG. 7.

It should be understood that some or all of the circuitry of FIGS. 1-3 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIGS. 1-3 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIGS. 1-3 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

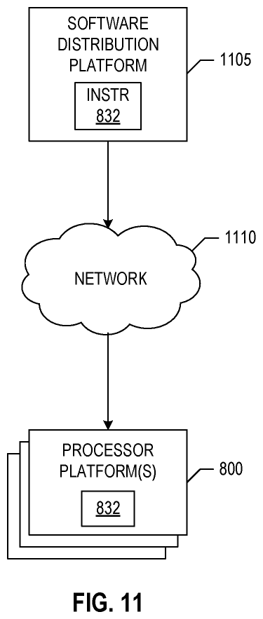

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIG. 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 7, may be downloaded to the example programmable circuitry platform 800, which is to execute the machine readable instructions 832 to implement the cloud manager 138. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that manage software projects across disparate portions of computing infrastructure. Certain examples enable synchronization of projects across infrastructure and cloud resources and help ensure that deleted projects can be restored or otherwise re-instantiated to avoid errors and faults in a computing environment. Disclosed systems, apparatus, articles of manufacture, and methods improve the efficiency of using a computing device by enabling projects to be created, synchronized, monitored, deleted, and restored dynamically between infrastructure automation and cloud services without introducing errors caused by accidental deletion, disconnect between infrastructure and cloud services, etc. Disclosed systems, apparatus, articles of manufacture, and methods are accordingly directed to one or more improvement(s) in the operation of a machine such as a computer or other electronic and/or mechanical device.

Example apparatus, systems, and methods to create, synchronize, manage, delete, and restore projects are disclosed herein. Further examples and combinations thereof include the following:
Example 1 is an apparatus including: interface circuitry; machine readable instructions; and programmable circuitry to at least one of instantiate or execute the machine readable instructions to: monitor first events for a first reference to a project, the project to coordinate access to computing resources in a cloud or hybrid cloud computing environment; manage a record stored for the project, the record including a status of the project, the status updated in response to the first reference; delete the project in response to a delete instruction in the first events when the status of the project indicates that the project is not in use; monitor second events for a second reference to the project; and restore the project when the second events include the second reference.
Example 2 includes the apparatus of example 1, wherein the programmable circuitry is to synchronize the project between an infrastructure automation manager and a cloud services manager.
Example 3 includes the apparatus of example 2, wherein the programmable circuitry is to maintain a first record of the project with the infrastructure automation manager and a second record of the project with the cloud services manager.
Example 4 includes the apparatus of example 3, wherein the programmable circuitry is to implement resource management circuitry in the cloud services manager and project migrator circuitry and synchronization circuitry in the infrastructure automation manager.
Example 5 includes the apparatus of example 4, wherein the project migration circuitry is to create the project with the resource management circuitry, and wherein the synchronization circuitry is to read the project from the resource management circuitry.
Example 6 includes the apparatus of example 1, wherein the programmable circuitry is to deny the delete instruction when the status of the project indicates that the project is in use.
Example 7 includes the apparatus of example 1, wherein the first events include at least one of a project creation, a project update, or a project deletion, the project delete associated with the delete instruction.
Example 8 includes the apparatus of example 1, wherein the programmable circuitry is to create a deployment using the project.
Example 9 includes the apparatus of example 8, wherein the programmable circuitry is to add a resource to the project.
Example 10 includes the apparatus of example 1, wherein the programmable circuitry is to periodically check to determine whether the project is in use and marks the status of the project as in use or not in use based on the determination.
Example 11 is a non-transitory machine readable storage medium including instructions to cause programmable circuitry to at least: monitor first events for a first reference to a project, the project to coordinate access to computing resources in a cloud or hybrid cloud computing environment; manage a record stored for the project, the record including a status of the project, the status updated in response to the first reference; delete the project in response to a delete instruction in the first events when the status of the project indicates that the project is not in use; monitor second events for a second reference to the project; and restore the project when the second events include the second reference.
Example 12 includes the non-transitory machine readable storage medium of example 11, wherein the instructions cause the programmable circuitry to synchronize the project between an infrastructure automation manager and a cloud services manager.
Example 13 includes the non-transitory machine readable storage medium of example 12, wherein the instructions cause the programmable circuitry to maintain a first record of the project with the infrastructure automation manager and a second record of the project with the cloud services manager.
Example 14 includes the non-transitory machine readable storage medium of example 11, wherein the instructions cause the programmable circuitry to deny the delete instruction when the status of the project indicates that the project is in use.
Example 15 includes the non-transitory machine readable storage medium of example 11, wherein the first events include at least one of a project creation, a project update, or a project deletion, the project delete associated with the delete instruction.
Example 16 includes the non-transitory machine readable storage medium of example 11, wherein the instructions cause the programmable circuitry to create a deployment using the project.
Example 17 includes the non-transitory machine readable storage medium of example 16, wherein the instructions cause the programmable circuitry to add a resource to the project.
Example 18 includes the non-transitory machine readable storage medium of example 11, wherein the instructions cause the programmable circuitry to periodically check to determine whether the project is in use and marks the status of the project as in use or not in use based on the determination.
Example 19 is a method including: monitoring, by executing an instruction using programmable circuitry, first events for a first reference to a project, the project to coordinate access to computing resources in a cloud or hybrid cloud computing environment; managing, by executing an instruction using the programmable circuitry, a record stored for the project, the record including a status of the project, the status updated in response to the first reference; deleting, by executing an instruction using the programmable circuitry, the project in response to a delete instruction in the first events when the status of the project indicates that the project is not in use; monitoring, by executing an instruction using the programmable circuitry, second events for a second reference to the project; and restoring, by executing an instruction using the programmable circuitry, the project when the second events include the second reference.
Example 20 includes the method of example 19, further including: periodically checking to determine whether the project is in use; and marking the status of the project as in use or not in use based on the determination.
Example 21 includes the method of example 20, further including: denying the delete instruction when the status of the project indicates that the project is in use.
Example 22 is an apparatus including: Means for monitoring first events; means for managing a record stored for the project; means for deleting the project; means for monitoring second events; and means for restoring the project.
Example 23 includes an infrastructure automation manager and a cloud services manager to implement the apparatus of any preceding clause.
Example 24 includes an infrastructure automation manager and a cloud services manager to execute the method of any preceding clause.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
interface circuitry;
machine readable instructions; and
programmable circuitry to at least one of instantiate or execute the machine readable instructions to:
monitor first events for a first reference to a project, the project to coordinate access to computing resources in a cloud or hybrid cloud computing environment;
manage a record stored for the project, the record including a status of the project, the status updated in response to the first reference;
delete the project in response to a delete instruction in the first events when the status of the project indicates that the project is not in use;
monitor second events for a second reference to the project; and
restore the project when the second events include the second reference.

2. The apparatus of claim 1, wherein the programmable circuitry is to synchronize the project between an infrastructure automation manager and a cloud services manager.

3. The apparatus of claim 2, wherein the programmable circuitry is to maintain a first record of the project with the infrastructure automation manager and a second record of the project with the cloud services manager.

4. The apparatus of claim 3, wherein the programmable circuitry is to implement resource management circuitry in the cloud services manager and project migrator circuitry and synchronization circuitry in the infrastructure automation manager.

5. The apparatus of claim 4, wherein the project migration circuitry is to create the project with the resource management circuitry, and wherein the synchronization circuitry is to read the project from the resource management circuitry.

6. The apparatus of claim 1, wherein the programmable circuitry is to deny the delete instruction when the status of the project indicates that the project is in use.

7. The apparatus of claim 1, wherein the first events include at least one of a project creation, a project update, or a project deletion, the project delete associated with the delete instruction.

8. The apparatus of claim 1, wherein the programmable circuitry is to create a deployment using the project.

9. The apparatus of claim 8, wherein the programmable circuitry is to add a resource to the project.

10. The apparatus of claim 1, wherein the programmable circuitry is to periodically check to determine whether the project is in use and marks the status of the project as in use or not in use based on the determination.

11. A non-transitory machine readable storage medium comprising instructions to cause programmable circuitry to at least:
monitor first events for a first reference to a project, the project to coordinate access to computing resources in a cloud or hybrid cloud computing environment;
manage a record stored for the project, the record including a status of the project, the status updated in response to the first reference;
delete the project in response to a delete instruction in the first events when the status of the project indicates that the project is not in use;
monitor second events for a second reference to the project; and
restore the project when the second events include the second reference.

12. The non-transitory machine readable storage medium of claim 11, wherein the instructions cause the programmable circuitry to synchronize the project between an infrastructure automation manager and a cloud services manager.

13. The non-transitory machine readable storage medium of claim 12, wherein the instructions cause the programmable circuitry to maintain a first record of the project with the infrastructure automation manager and a second record of the project with the cloud services manager.

14. The non-transitory machine readable storage medium of claim 11, wherein the instructions cause the programmable circuitry to deny the delete instruction when the status of the project indicates that the project is in use.

15. The non-transitory machine readable storage medium of claim 11, wherein the first events include at least one of a project creation, a project update, or a project deletion, the project delete associated with the delete instruction.

16. The non-transitory machine readable storage medium of claim 11, wherein the instructions cause the programmable circuitry to create a deployment using the project.

17. The non-transitory machine readable storage medium of claim 16, wherein the instructions cause the programmable circuitry to add a resource to the project.

18. The non-transitory machine readable storage medium of claim 11, wherein the instructions cause the programmable circuitry to periodically check to determine whether the project is in use and marks the status of the project as in use or not in use based on the determination.

19. A method comprising:
monitoring, by executing an instruction using programmable circuitry, first events for a first reference to a project, the project to coordinate access to computing resources in a cloud or hybrid cloud computing environment;
managing, by executing an instruction using the programmable circuitry, a record stored for the project, the record including a status of the project, the status updated in response to the first reference;
deleting, by executing an instruction using the programmable circuitry, the project in response to a delete instruction in the first events when the status of the project indicates that the project is not in use;
monitoring, by executing an instruction using the programmable circuitry, second events for a second reference to the project; and
restoring, by executing an instruction using the programmable circuitry, the project when the second events include the second reference.

20. The method of claim 19, further including:
periodically checking to determine whether the project is in use; and
marking the status of the project as in use or not in use based on the determination.

21. The method of claim 20, further including:
denying the delete instruction when the status of the project indicates that the project is in use.
